(19) United States
(12) Patent Application Publication
(10) Pub. No.: US 2018/0096286 A1
(43) Pub. Date: Apr. 5, 2018

(54) WORKFLOW LABOR OPTIMIZATION SYSTEM

(71) Applicant: Christopher Cook, Orange, CA (US)

(72) Inventor: Christopher Cook, Orange, CA (US)

(21) Appl. No.: 15/716,312

(22) Filed: Sep. 26, 2017

Related U.S. Application Data
(60) Provisional application No. 62/402,527, filed on Sep. 30, 2016.

(51) Int. Cl. G06Q 10/06; G06Q 10/10

(52) U.S. Cl. CPC G06Q 10/063116; G06Q 10/06316; G06Q 10/063112; G06Q 10/1097

(57) ABSTRACT

An apparatus and methods are provided for a workflow labor optimization system configured to enable a multiplicity of end-users to assign groups of specialized workers to perform diverse tasks that meet the needs of business clients. The workflow labor optimization system includes a work partitioning system that enables the end-users to divide new work into logical groups of tasks, arrange complimentary tasks into workitem sequences that are tailored to address the needs of the business clients, and organize the workitem sequences into workflows. A dependencies system enables the end-users to initiate work by establishing predecessors within individual workitems and by wiring tasks between different workitems. An interval system enables the end-users to control the progression of workitems by establishing due dates between various tasks comprising the workitems. A labor functionalization system enables the end-users to select workers from specialized labor pools and pair the workers with appropriate tasks.

### PRIORITY

This application claims the benefit of and priority to U.S. Provisional Application, entitled “Workflow Labor Optimization System,” filed on Sep. 30, 2016 and having application Ser. No. 62/402,527.

### FIELD

The field of the present disclosure generally relates to optical communications networks. More particularly, the field of the invention relates to a system and methods for optimally assigning a labor pool comprised of multiple groups of specialized workers to perform a multiplicity of diverse tasks during installation of optical communications networks.

### BACKGROUND

Fiber to the home (FTTH) is a delivery of a communications signal over optical fiber from an operator's switching equipment all the way to a home or business, thereby replacing existing metallic conductor infrastructure such as copper telephone wires and coaxial cable. Fiber to the home is a relatively new and fast-growing method of providing vastly superior bandwidth to consumers and businesses, and thereby enabling more robust video, internet, and voice services.

Connecting homes directly to fiber optic cable enables enormous improvements in the bandwidth that can be provided to consumers. The transmission characteristics of light over glass is superior to anything else on the market. Placing fiber to the home shifts the onus of network upgrades to end-equipment, rather than relying upon much costlier upgrades to the transmission medium itself. Current fiber optic technology can provide transmission speeds of up to 1000 megabits per second. Further, as cable modem and DSL providers are struggling to squeeze increments of higher bandwidth out of their legacy technologies, ongoing improvements in fiber optic equipment are constantly increasing available bandwidth without having to change the fiber optic cables.

A difficultly associated with FTTH, however, is that the existing infrastructure must be identified and mapped to each home or business, and appropriate sizes and spans of fiber optic cables, as well as associated hardware, must be designed so as to logically route the fiber optic cables to each home or business. Thus, successfully implementing FTTH generally requires a labor pool comprised of multiple groups of specialized technicians, and other workers, having diverse experiential backgrounds and expertise. Properly coordinating several groups of workers has the potential to increase the speed of an installation of FTTH, as well as improve the quality of the installation. Further, an effective coordination of groups of workers generally decreases downtime between various portions of the installation, and decreases overlapping and repetition of work that may be performed by different groups of workers, thereby increasing profitability. What is needed, therefore, is a system for optimally assigning a labor pool comprised of multiple groups of workers to perform a multiplicity of diverse tasks during installation of optical communications networks.

### SUMMARY

An apparatus and methods are provided for a workflow labor optimization system configured to enable a multiplicity of end-users to assign multiple groups of specialized workers to perform diverse tasks that meet the needs of one or more business clients. The workflow labor optimization system comprises a configuration system that includes a work partitioning system configured to enable the end-users to organize new work into logical groups of tasks, arrange complimentary tasks into workitem sequences that are tailored to address the needs of the business clients, and organize the workitem sequences into workflows. A dependencies system is configured to enable the end-users to initiate work by establishing predecessors within individual workitems and by wiring tasks between different workitems. An interval system is configured to enable the end-users to control the progression of workitems by establishing due dates and due date rules between various tasks comprising the workitems. A labor functionalization system is configured to enable the end-users to select workers from specialized labor pools and pair the workers with appropriate tasks. The workers may be paired based on the types of inbound tasks, employee qualifications, an allotted time to complete each of the tasks, employee work capacity, current workload, forecasted employee work capacity, as well as any other factors that may arise having a bearing on performing the tasks.

In an exemplary embodiment, a workflow labor optimization system configured to enable a multiplicity of end-users to assign groups of specialized workers to perform diverse tasks that meet the needs of one or more business clients comprises: a work partitioning system configured to enable the multiplicity of end-users to at least organize new work into logical groups of tasks, arrange complimentary tasks into workitem sequences that are tailored to address the needs of the one or more business clients, and organize the workitem sequences into workflows; a dependencies system configured to enable the multiplicity of end-users to at least initiate work by establishing a schedule whereby workitems may be completed; an interval system configured to enable the multiplicity of end-users to control the progression of workitems by establishing at least due dates and due date rules between tasks comprising the workitems; a labor functionalization system configured to enable the multiplicity of end-users to at least select workers from specialized labor pools and pair the workers with appropriate tasks; a host site configured to be accessible to the multiplicity of end-users by way of a communications network; and a database server system comprising a non-transient machine-readable medium for storing information needed during the operation of the workflow labor optimization system.

In another exemplary embodiment, the host site is configured to provide the multiplicity of end-users with access to the workflow labor optimization system by way of an interface. In another exemplary embodiment, the work partitioning system comprises a component systems package that is configured to be stored on a memory of an application server system, and wherein the interface is configured as a software application comprising a portion of the workflow labor optimization system and providing access thereto. In another exemplary embodiment, the work partitioning system comprises a component systems package that is configured to be stored on a memory of the database server system, and wherein the interface is configured to provide communication between an application server system and the component systems package.

In another exemplary embodiment, the dependencies system is configured to enable the multiplicity of end-users to assign predecessors to tasks comprising one or more workitems so as to control the progression of the one or more workitems. In another exemplary embodiment, the dependencies system is configured to enable the multiplicity of end-users to control the progression of a workflow by establishing links between tasks comprising different workitems within the workflow, the links being comprised of wires placed between the tasks. In another exemplary embodiment, the interval system is configured to enable the multiplicity of end-users to set Time Units and Due Date Rules for one or more tasks comprising a workitem so as to control when the one or more tasks are to be performed in relation to a Project Received Date and relative to one another of the one or more tasks.

In another exemplary embodiment, the labor functionalization system is configured to enable the workers to be paired with the appropriate tasks based on factors that affect performing the tasks, including at least the types of inbound tasks, employee qualifications, an allotted time to complete each of the tasks, employee work capacity, current workload, forecasted employee work capacity. In another exemplary embodiment, a portion of the labor functionalization system comprises a constraints solver that is configured to assign the inbound tasks to the most suitable workers based on criteria specified by the multiplicity of end-users. In another exemplary embodiment, the portion of the labor functionalization system is configured to return an assignment result once all of the inbound tasks are paired with suitable workers.

In another exemplary embodiment, the labor functionalization system comprises a knowledge base configured to serve as a record of all those certain workers that are assigned to perform currently pending tasks. In another exemplary embodiment, the knowledge base contains all the tasks that are scheduled to be performed, as well as an individual work queue for each of the workers assigned to work on the tasks pertaining to the one or more business clients. In another exemplary embodiment, the knowledge base is configured to facilitate making any necessary changes to any portion or aspect of the tasks pertaining to the one or more business clients.

In an exemplary embodiment, a method for a workflow labor optimization system to enable a multiplicity of end-users to assign groups of workers to perform tasks that meet the needs of one or more business clients comprises: enabling new work to be partitioned into logical groups of tasks and arranged into workitems; allowing a schedule to be established whereby the workitems may be completed; allowing at least due dates and due date rules to be associated with the tasks to control the progression of workitems; enabling workers to be paired with appropriate tasks comprising the workitems; providing a host site whereby the multiplicity of end-users may access the workflow labor optimization system; and storing information needed during operation of the workflow labor optimization system on a non-transient machine-readable medium of a database server system.

In another exemplary embodiment, providing the host site comprises making the host site accessible to the multiplicity of end-users by way of a communications network. In another exemplary embodiment, allowing the schedule to be established further comprises providing a dependencies system whereby the multiplicity of end-users may assign predecessors to tasks comprising one or more workitems so as to control the progression of the one or more workitems. In another exemplary embodiment, providing the dependencies system further comprises enabling the multiplicity of end-users to control the progression of the workitems by establishing links between tasks within the one or more workitems. In another exemplary embodiment, allowing at least due dates and due date rules further comprises configuring an interval system to enable the multiplicity of end-users to control the progression of workitems by associating the at least due dates and the due date rules with the tasks comprising the workitems.

In another exemplary embodiment, enabling workers to be paired further comprises providing a labor functionalization system whereby the multiplicity of end-users may select the workers from specialized labor pools and assign the workers to perform the most appropriate of the tasks. In another exemplary embodiment, enabling new work to be partitioned further comprises providing a work partitioning system whereby the multiplicity of end-users may at least arrange complimentary tasks into workitem sequences and organize the workitem sequences into workflows that are tailored to address the needs of the one or more business clients.

### BRIEF DESCRIPTION OF THE DRAWINGS

The drawings refer to embodiments of the present disclosure in which:

FIG. 1 is a schematic illustrating an exemplary embodiment of a workflow labor optimization system according to the present disclosure;

FIG. 2 illustrates an exemplary embodiment of a method whereby the workflow labor optimization system may be used to assign a labor pool to perform new work;

FIG. 3 illustrates a relationship between tasks, workitems, and workflows, whereby a work partitioning system may be used to tailor inbound work to address the needs of a business unit;

FIG. 4A illustrates an exemplary embodiment of a container that groups one or more clusters into a job;

FIG. 4B illustrates an embodiment of a relationship between multiple workflows that are tailored for a specific business unit and an exemplary embodiment of a newly created cluster;

FIG. 5A illustrates an exemplary workitem that is comprised of multiple tasks and predecessors;

FIG. 5B illustrates a sequence of tasks that are performed as the exemplary workitem of FIG. 5A is progressed from a start state to a completion state;

FIG. 6 illustrates an exemplary group of workitems that are each comprised of multiple tasks and include multiple dependencies that affect the progression rate of the group of workitems;

FIG. 7 illustrates an exemplary workflow that is comprised of multiple tasks and includes date placeholders that control when the tasks are to be performed in relation to a project received date and relative to one another;

FIG. 8 illustrates an exemplary embodiment of a pairing of inbound tasks with suitably specialized workers by way of a constraints solver; and

FIG. 9 illustrates an exemplary embodiment of a knowledge base whereby workers within a labor pool may be assigned to portions of a project on the basis of their knowledge, qualifications, skills, and the like.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first task,” may be made. However, the specific numeric reference should not be interpreted as a literal sequential order but rather interpreted that the “first task” is different than a “second task.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, the present disclosure describes an apparatus and methods for a workflow labor optimization system comprising tools for optimally assigning a labor pool comprised of multiple groups of specialized workers to perform diverse tasks that meet the needs of a business client. The workflow labor optimization system is comprised of a configuration system that includes a component systems package. The component systems package is comprised of a work partitioning system configured to enable a multiplicity of end-users to divide new work into logical groups of tasks, arrange related or complimentary tasks into workitem sequences that are tailored to address the needs of a business unit, and organize one or more workitems sequences into workflows. A dependencies system enables the end-users to initiate or “fire” work by linking one or more tasks within individual workitems and by connecting tasks between different workitems. An interval system enables the end-users to control the progression of workitems by establishing due dates and due date rules between various tasks comprising the workitems. A labor functionalization system enables the end-users to select one or more workers from one or more specialized labor pools and pair the workers with appropriate tasks based on criteria specified by the end-users, including, but necessarily limited to the types of inbound tasks, employee qualifications, an allotted time to complete each of the tasks, employee work capacity, current workload, forecasted work capacity of the workers, as well as any other factors that may arise having a bearing on performing the tasks. A host site may be configured to provide the multiplicity of end-users with access to the configuration system by way of a communications network, such as the Internet.

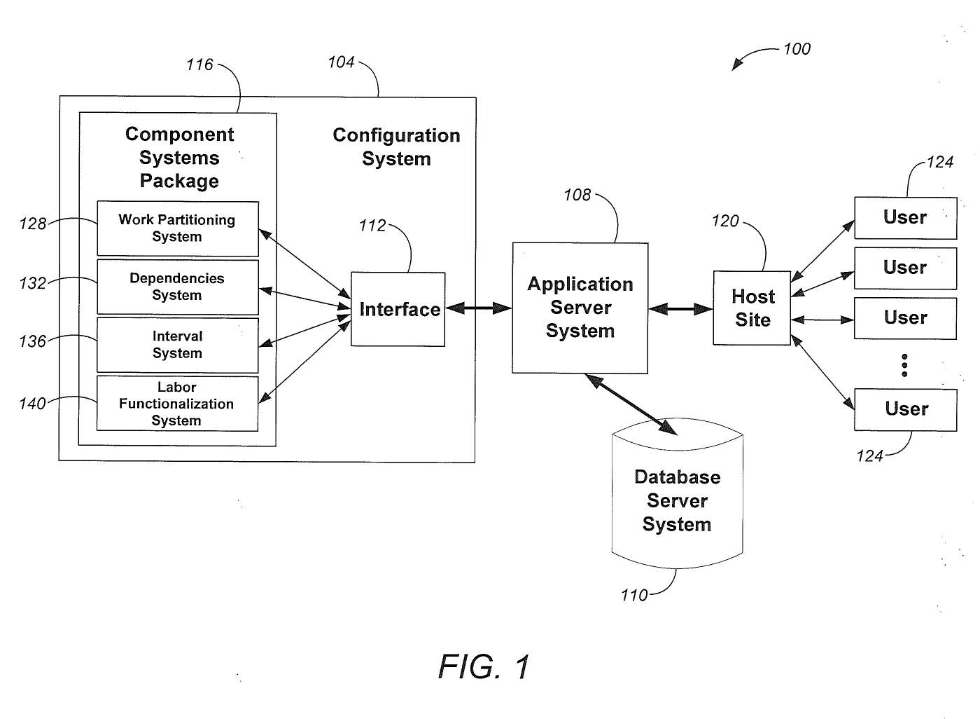

FIG. 1 is a schematic illustrating an exemplary embodiment of a workflow labor optimization system 100 according to the present disclosure. In the illustrated embodiment, the workflow labor optimization system 100 comprises a configuration system 104 stored on a non-transient machine-readable medium (i.e., a memory) of an application server system 108. The workflow labor optimization system 100 may be further comprised of a database server system 110 which stores any information or data that may be needed during the operation of the configuration system 104.

The configuration system 104 may comprise an interface 112 which provides access to a component systems package 116. As illustrated in the embodiment of FIG. 1, a host site 120 may provide a multiplicity of end-users 124 access to the application server system 108 by way of a communications network, such as the Internet. It is envisioned that at least a portion of the multiplicity of end-users 124 may comprise personnel desiring to assign groups of specialized workers to perform appropriate tasks during an installation of a proposed fiber optic communications network. A remaining portion of the end-users 124 may be personnel charged with reviewing, revising, or overseeing the assignment of work, as needed, as well as members of the groups of specialized workers receiving assignments or signifying completion of previously assigned work. In some embodiments, each of the end-users 124 may create a user profile by utilizing applications stored on the memory of the application server system 108 and the services provided by the configuration system 104.

In one embodiment, the component systems package 116 may be stored on the memory of the application server system 108, and the interface 112 may be a software application that comprises a portion of the configuration system 104, thereby providing access to the component systems package 116. In another embodiment, the component systems package 116 may be stored on the memory of the database server system 110, and the interface 112 may enable interaction between the application server system 108 and the component systems package 116 on the database server system 110. In still another embodiment, the component systems package 116 may be services operated by one or more third-party service providers. In such an embodiment, the interface 112 may comprise a connection over the communications network, such as an Internet connection, whereby the application server system 108 may send requests to, and receive services from the one or more third-party service providers.

In the embodiment illustrated in FIG. 1, the component systems package 116 comprises services that are provided to the end-users 124, including, but not necessarily limited to a work partitioning system 128, a dependencies system 132, an interval system 136, and a labor functionalization system 140. As described herein, the workflow labor optimization system 100 generally provides the end-users 124 with tools for assigning groups of specialized workers to perform appropriate portions of a pool of work. Although the workflow labor optimization system 100 is particularly well suited for coordinating workers during installations of fiber optic communications networks, the workflow labor optimization system 100 should be understood to be at least equivalently suitable for pools of work other than fiber optic communications networks that require coordination of multiple personnel.

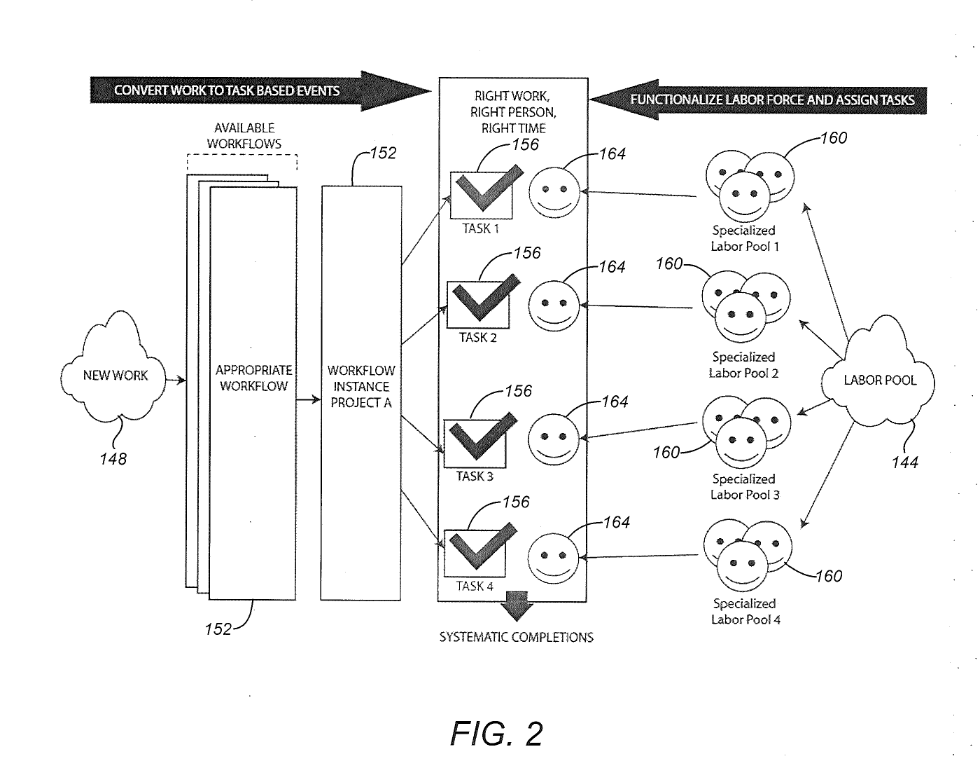

FIG. 2 illustrates an exemplary embodiment of a method whereby the workflow labor optimization system 100 may be used to assign a labor pool 144 to perform new work 148. In the illustrated embodiment, new work 148 is partitioned into a multiplicity of workflows 152, each of which being comprised of a multiplicity of tasks 156. It is contemplated, that the multiplicity of tasks 156 may be arranged into any of various logical sequences that facilitates an optimal completion of the workflow 152. The labor pool 144 is organized into multiple specialized labor pools 160. As will be appreciated, the labor pool 144 is comprised of workers having disparate expertise and levels of experience. It is envisioned that, in one embodiment, each of the specialized labor pools 160 may be comprised of groups of workers having similar expertise and experience. In the embodiment illustrated in FIG. 2, one or more workers 164 may be selected from each specialized labor pool 160 and paired with an appropriate task 156. It is contemplated that workers 164 may be assigned to work on tasks 156 with which they have existing expertise so as to facilitate systematic completion of the workflow 152.

In the embodiment illustrated in FIG. 1, the work partitioning system 128 comprises an interface that enables the end-user 124 to divide new work 148 into logical groups of tasks 156. Each of the tasks 156 may be comprised of a specific, system-prescribed work step. For example, in some embodiments, a first task 156 may be comprised of mapping existing network connections to each home or business within a proposed area. A second task 156 may be comprised of designing an optical network and routing optical cables to the homes or businesses. The work partitioning system 128 enables the end-user 124 to add the tasks 156 to a task library 168 that may be stored on the database server system 110.

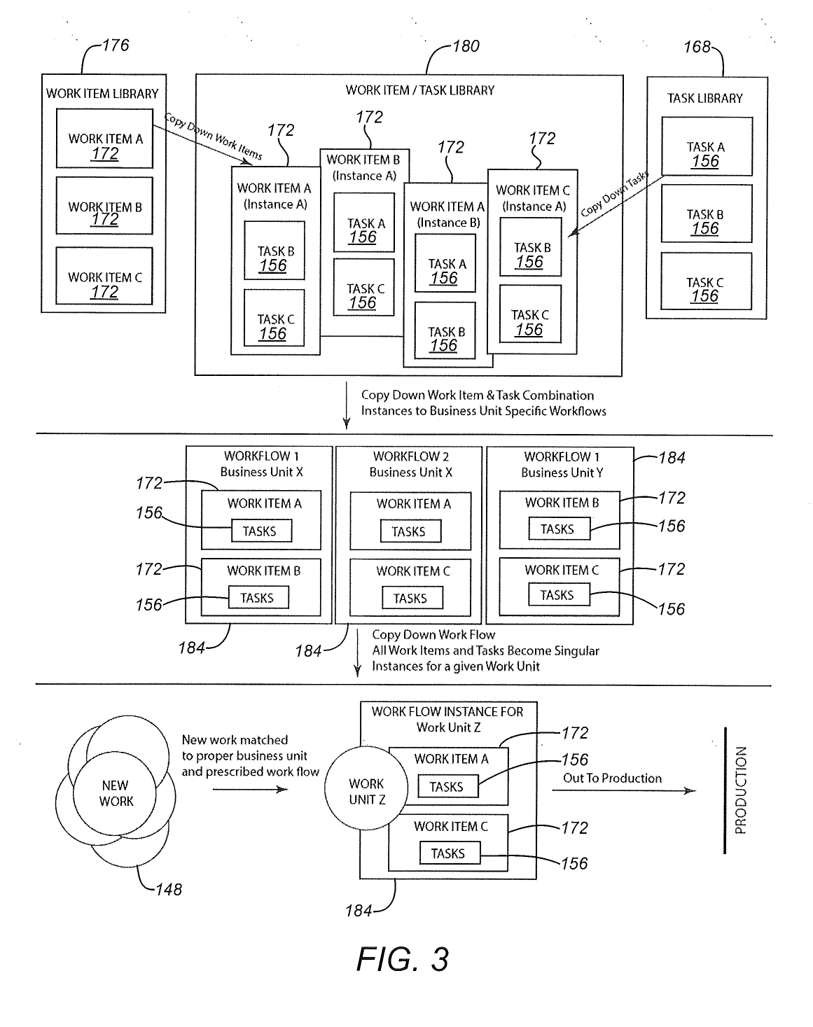

As best illustrated in FIG. 3, the end-user 124 may copy or import one or more tasks 156 from within the task library 168 and then group the tasks into a workitem 172. Preferably, each workitem 172 is comprised of a sequence of one or more related or complimentary tasks 156. For example, a first instance of Workitem A may be comprised of Task B and Task C, and a second instance of Workitem A may be comprised of Task A and Task B. Meanwhile, a first instance of Workitem B may be comprised of Task A and Task C, and a first instance of Workitem C may be comprised of Task B and Task C. It is contemplated that the tasks 156 may be as general or granular as is desired. The work partitioning system 128 enables the end-user 124 to add the workitems 172 to a workitem library 176 that may be stored on the database server system 110.

As will be recognized, the end-user 124 may create multiple workitems 172, each comprising combinations of tasks 156, logically arrange to meet the needs of various business customers, or “business units.” Thus, the first instance of Workitem A that is tailored to suit the needs of a first business unit may be substantially similar, but not necessarily identical, to the second instance of Workitem A that is tailored for a second business unit. As such, the work partitioning system 128 enables the end-user 124 to manipulate the workitems 172, and the tasks 156 therein, as needed, and add the workitems to a workitem-task library 180. It will be appreciated that the workitem-task library 180 facilitates quickly and easily recalling existing workitems 172 without the burden of reassembling sequences of tasks 156 for familiar business units.

As illustrated in FIG. 3, the work partitioning system 128 is configured to enable combining the workitems 172 into workflows 184 that are tailored to address the needs of each business unit. In general, a workflow 184 may be comprised of a collection of workitems 172 arranged with logical connections that facilitate a systematic completion of the tasks 156 comprising the workflow. In some embodiments, each of the workflows 184 may be comprised of two or more workitems 172 that are connected in series, and thus the workitems are to be completed sequentially. In some embodiments, each of the workflows 184 may be comprised of two or more workitems 172 that share parallel connections, and thus are to be completed substantially simultaneously. As will be appreciated, however, each workflow 184 may be comprised of any combination of parallel and series connected workitems 172, as is required to systematically complete the tasks 156 comprising the workflow.

Moreover, the work partitioning system 128 is configured to facilitate tailoring workflows 184 to accommodate the needs of a multiplicity of business units. For example, in the illustrated embodiment of FIG. 3, a first workflow 184, labeled as Workflow 1, tailored for Business Unit X may be comprised of Workitem A and Workitem B. A second workflow 184, labeled Workflow 2, also tailored for Business Unit X may be comprised of Workitem A and Workitem C. Meanwhile, another instance of Workflow 1 may be tailored for Business Unit Y and comprised of Workitem B and Workitem C. It is contemplated, therefore, that the workflows 184 may be stored on the database server system 110 and used as templates to organize new work 148. In the embodiment of FIG. 3, new work 148 may be matched to appropriate business units and then organized into suitable workflow instances before being sent to production.

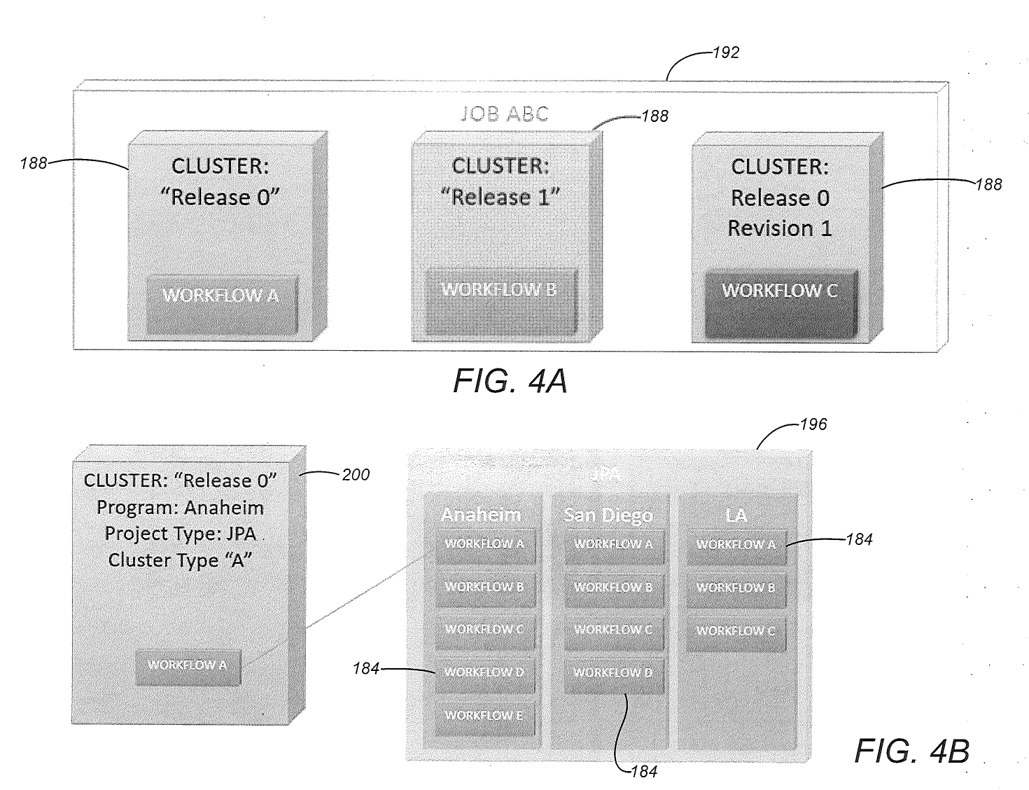

In some embodiments, one or more workflows 184 that are to be performed for a particular business unit may be arranged into a grouping of work that is deliverable to the business unit. In some embodiments, these groupings are referred to as “clusters” 188 that operate as containers for the one or more workflows 184. Further, as shown in FIG. 4A, one or more clusters may be grouped into containers called “jobs” 192. Although a job typically comprises a customer-defined unit of work, jobs 192 may be comprised of any combination of workflows 184 related to customer job numbers, intent numbers, trouble ticket numbers, and the like. FIG. 4B illustrates one embodiment of a relationship between the workflows 184 tailored for an exemplary business unit, stored in a library 196 on the database server system 110, and an exemplary embodiment of a newly created cluster 200. At creation, the cluster 200 may be assigned attributes, such as, by way of non-limiting example, program identification, project type, cluster type, and the like. Once the attributes are assigned to the cluster 200, the cluster may be populated with appropriate workflows 184 that are stored in the library 196.

Once new work 148 has been arranged as described above, a schedule may be created according to which the work is to be performed by the workers 164, referred to as “firing work.” The dependencies system 132, discussed with respect to FIG. 1, is configured to enable the end-users 124 to fire work from each workitem 172 or task 156 to the next. Preferably, the dependencies system 132 enables the end-user 124 to fire work by establishing predecessors within individual workitems 172 and connecting, or “wiring,” tasks 156 between different workitems 172.

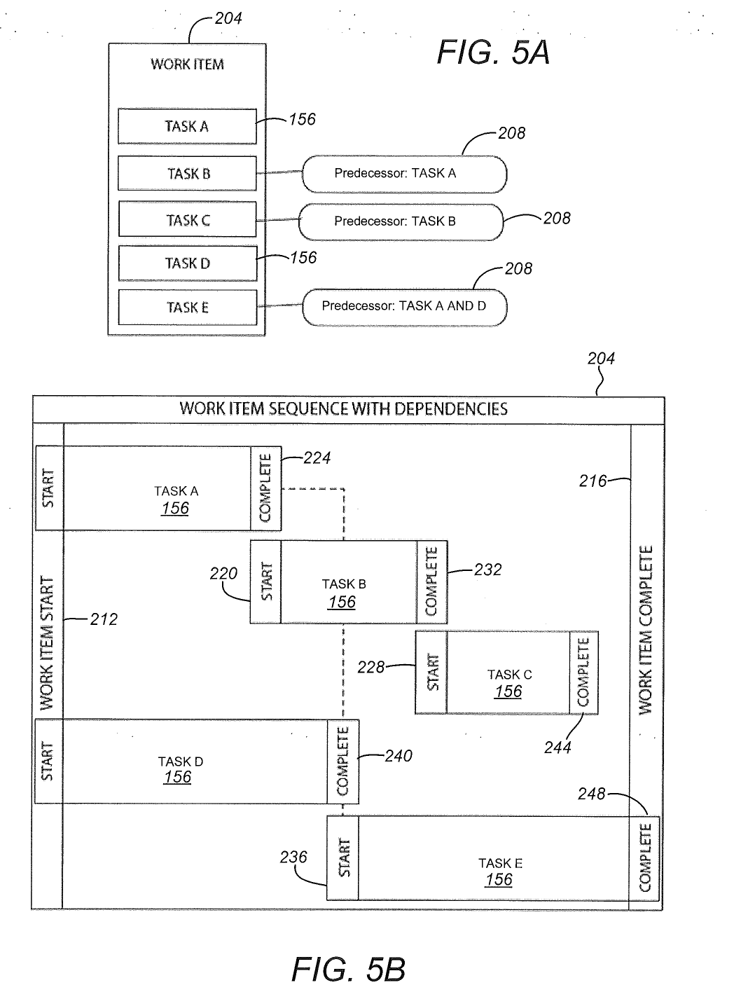

FIG. 5A illustrates an exemplary embodiment of a workitem 204 that is comprised of Tasks A-E and three predecessors 208. In the illustrated embodiment, Task B includes a predecessor 208 that specifies Task A. The predecessor 208 signals that Task A must be complete before Task B may begin. Task C includes a predecessor 208 specifying Task B, and Task E includes a predecessor 208 specifying both Tasks A and D. Thus, Task B must be completed before Task C may start, and Task E must wait for completion of both Tasks A and D. Further, Task A and Task D lack a predecessor 208, and thus Tasks A and D may be started either simultaneously or independently of one another.

FIG. 5B illustrates a sequence of Tasks A-E that are performed as the exemplary workitem 204 is progressed from a start state 212 to a completion state 216. Referring to FIG. 5A, it will be recognized that neither of Tasks A and D includes a predecessor, and thus both Tasks A and D may start simultaneously at the start state 212. Task B may begin at a start state 220 only once Task A reaches a complete state 224 due to the predecessor 208 included with Task B. Since Task C includes the predecessor 208 shown in FIG. 5A, Task C may begin at a start state 228 only once Task B reaches a complete state 232. Meanwhile, Task E may begin at a start state 236 once both Task A reaches the complete state 224 and Task D reaches a complete state 240. As will be appreciated, the start state 236 of Task E is independent of the progress of Tasks B and C due to the predecessor included in Task E shown in FIG. 5A. Once Task C reaches a complete state 244 and Task E reaches a complete state 248, the workitem 204 finishes in the completion state 216.

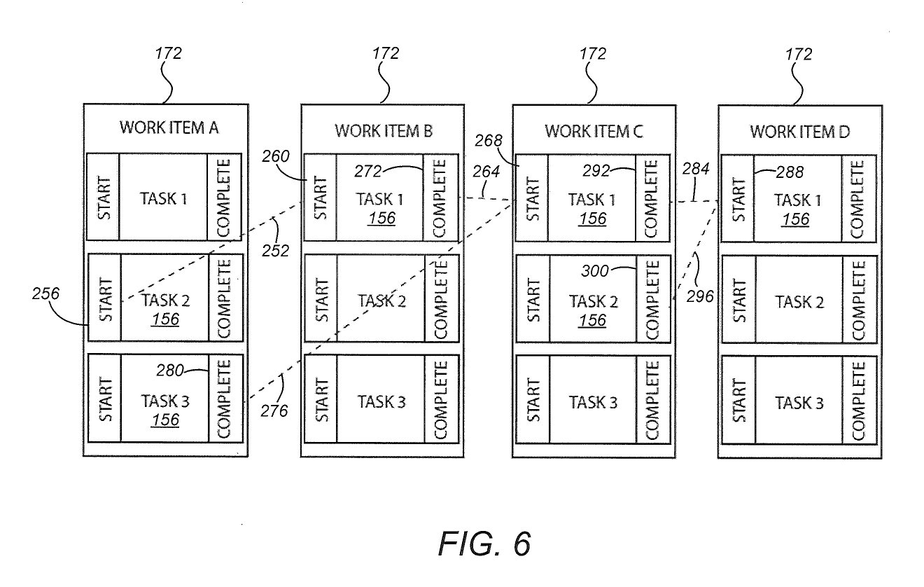

As mentioned above, the dependencies system 132 is configured to enable the end-user 124 to fire work by wiring tasks 156 between different workitems 172. FIG. 6 illustrates exemplary Workitems A-D that are each comprised of Tasks 1-3 and include multiple dependencies, and thus are comprised of wired tasks 156. The wired tasks 156 affect the progression rate of the group of Workitems A-D. For example, a wire 252 links a start state 256 of Task 2 in Workitem A and a start state 260 of Task 1 in Workitem B. The wire 252 triggers Task 1 in Workitem B to begin at the same time that Task 2 in Workitem A begins. Further, in some embodiments, multiple dependencies may be established between the tasks 156 in different workitems 172. In the illustrated example of FIG. 6, a first wire 264 links a start state 268 of Task 1 in Workitem C with a complete state 272 of Task 1 in Workitem B, and a second wire 276 links the start state 268 with a complete state 280 of Task 3 in Workitem A. Thus, Task 1 in Workitem C may begin only upon completion of both Task 3 in Workitem A and Task 1 in Workitem B. Similarly, a first wire 284 links a start state 288 of Task 1 in Workitem D with a complete state 292 of Task 1 in Workitem C, and a second wire 296 links the start state 288 with a complete state 300 in Task 2 of Workitem C. The wires 284, 296 ensure that Task 1 in Workitem D may begin only upon completion of both Tasks 1 and 2 in Workitem C.

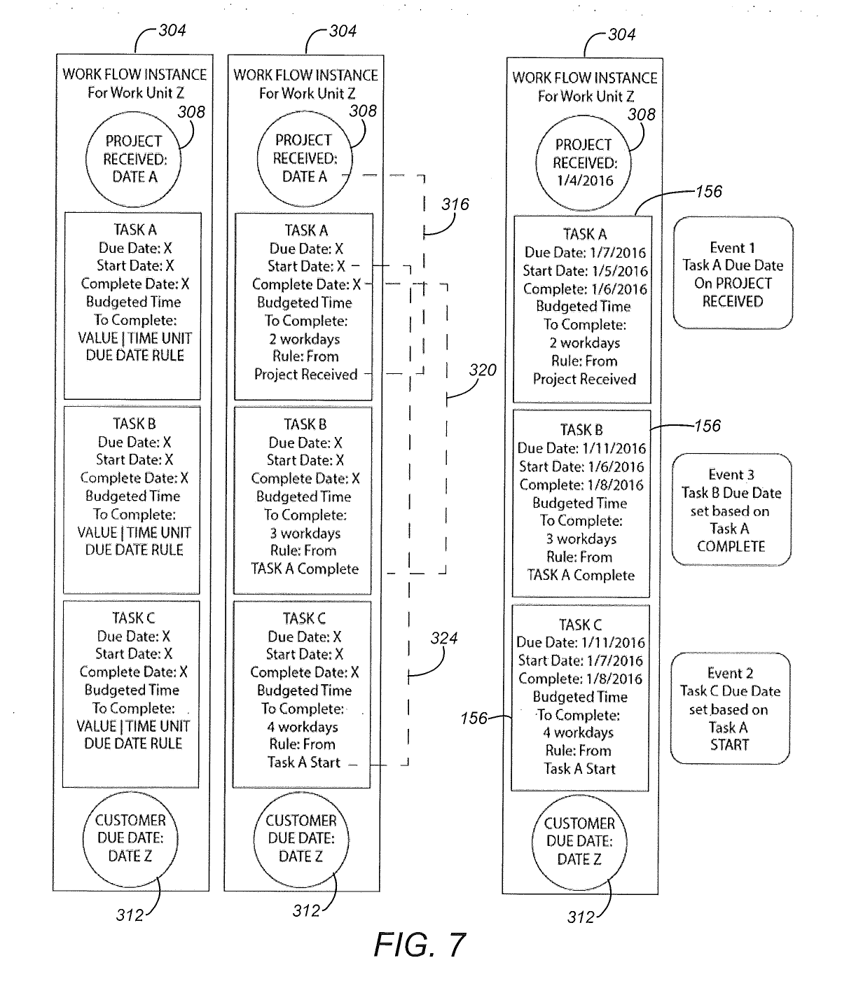

In addition to firing work by establishing predecessors 208 and wiring tasks 156, the progression of workitems 172 may be controlled by assigning due dates and due date rules to tasks 156. The interval system 136, illustrated in FIG. 1, is configured to enable the end-user 124 to establish due dates and due date rules between various tasks 156. FIG. 7 illustrates an exemplary workflow 304 that is comprised of Tasks A-C and includes a Project Received Date placeholder 308 and a Due Date placeholder 312. Each of the Tasks A-C is comprised of several date-related placeholders, such as, but not necessarily limited to Due Date, Start Date, Complete Date, Budgeted Time, Time Unit, and Due Date Rule. In particular, the end-user 124 may use the interval system 136 to set Time Units and Due Date Rules for Tasks A-C. When the workflow 304 is later assigned for completion, the Time Units and Due Date Rules will operate to control when Tasks A-C are to be performed in relation to the Project Received Date and relative to one another.

As a specific example, in the embodiment illustrated in FIG. 7, the Time Unit for Task A is set to two workdays and the Due Date Rule is set to follow the Project Received Date, as indicated by a wire 316. Thus, Task A has a due date that is two workdays after the date on which the project is received. Further, Task B is set to have a Time Unit of three workdays and a Due Date Rule following the completion of Task A, indicated by a wire 320. This specifies that Task B must be completed no later than three workdays after Task A is completed. Meanwhile, the Time Unit for Task C is set to four workdays and the Due Date Rule is based on the Start Date of Task A, as indicated by a wire 324. Therefore, Task C is scheduled to be completed no later than four workdays after the start date of Task A. As shown in FIG. 7, once a specific date is entered into the Project Received Date placeholder 308, Tasks A-C are populated with appropriate dates based on the Time Units and Due Date Rules established by the end-user 124.

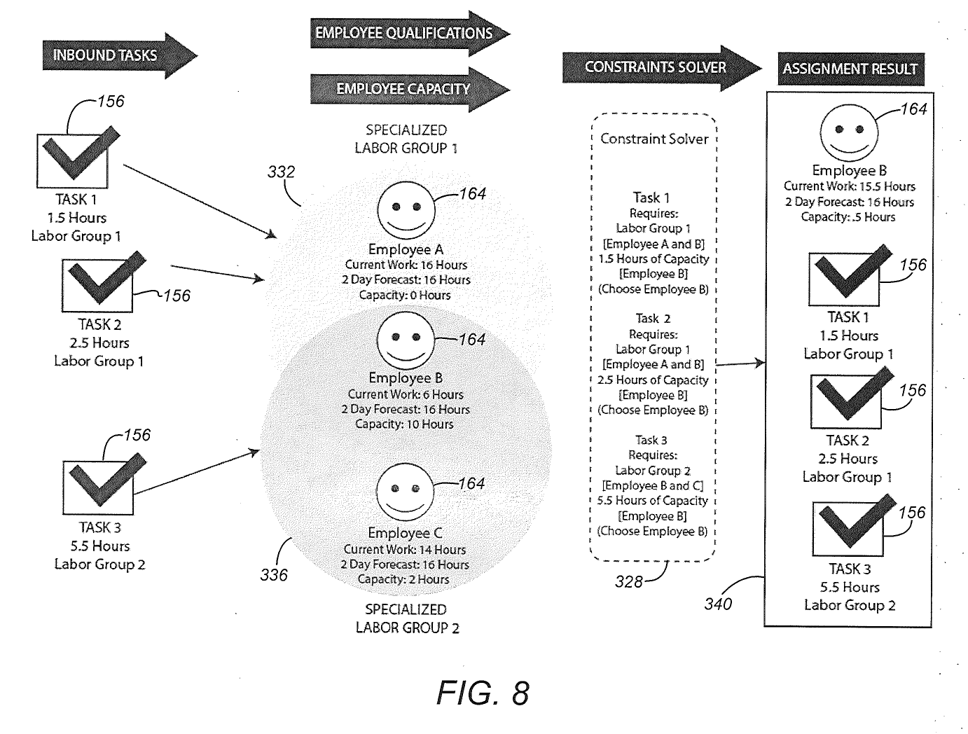

Referring again to FIGS. 1 and 2, the labor functionalization system 140 is configured to enable the end-user 124 to select one or more workers 164 from one or more specialized labor pools 160 and pair the workers with appropriate tasks 156. As shown in FIG. 8, the workers 164 preferably may be paired with suitable tasks 156 based on criteria specified by the end-user 124, such as, but not necessarily limited to the types of inbound tasks, employee qualifications, an allotted time to complete each of the tasks, employee work capacity, current workload, forecasted employee work capacity, as well as any other factors that may arise having a bearing on performing the tasks 156. In some embodiments, a portion of the labor functionalization system 140 comprises a constraints solver 328 that is configured to optimally assign the tasks 156 to the most suitable workers 164 by using the above-mentioned criteria.

FIG. 8 illustrates an exemplary embodiment of the operation of the constraints solver 328. As shown, a first labor group 332 is comprised of an Employee A and an Employee B. A second labor group 336 is comprised of Employee B and an Employee C. As will be recognized, Employee B resides in both the first and second labor groups 332, 336, and therefore may be assigned to work on tasks 156 that are directed to either of the first and second labor groups. Upon receiving an inbound task 156, labeled Task 1, that is directed to the first labor group 332, the constraints solver 328 may weigh the allotted time required to complete the task with the available work capacity of each of Employees A and B. As shown in FIG. 8, the constraints solver 328 will assign Task 1 to Employee B because the allotted time to complete Task 1 does not exceed the work capacity of Employee B. Similarly, the constraints solver 328 will assign an inbound Task 2 to Employee B because the sum of the allotted time to complete both Task 1 and Task 2 does not exceed the work capacity of Employee B. Further, an inbound Task 3 that is directed to the second labor group 336 will be assigned to Employee B, as well. In the case of Task 3, the constraints solver 328 will determine that the allotted time to complete Task 3 exceeds the work capacity of Employee C, whereas Employee B has a sufficient amount of remaining work capacity after being assigned Task 1 and Task 2. Once the constraints solver 328 pairs all of the inbound tasks 156 with suitable workers 164, the constraints solver 328 returns an assignment result 340 that indicates that all inbound tasks 156 have been assigned by the constraints solver 328 to the most qualified workers 164 without exceeding their individual work capacities.

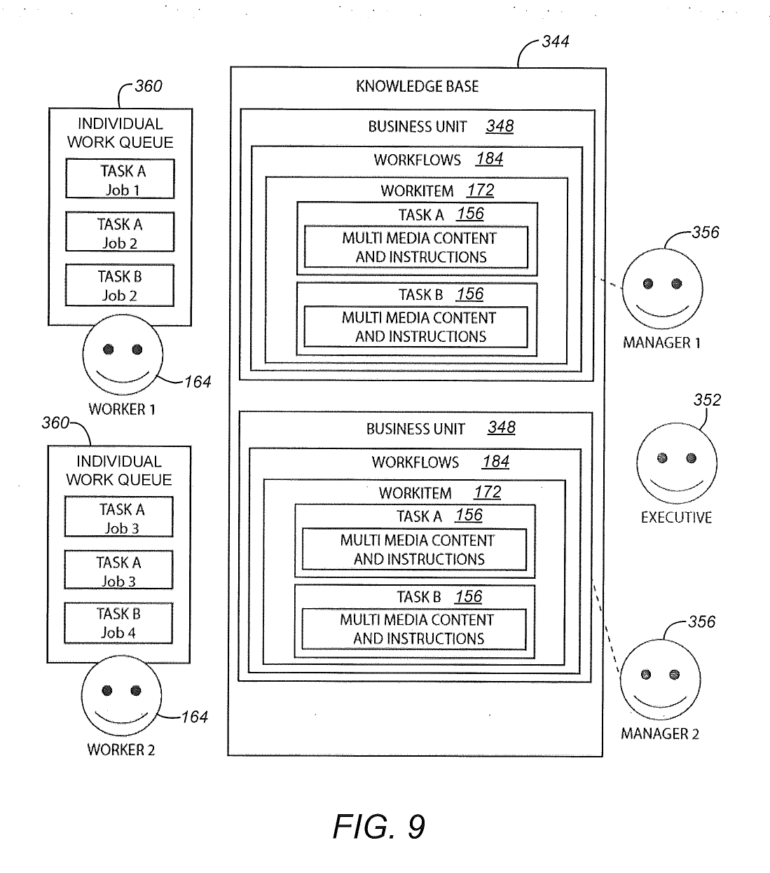

It is contemplated that, in some embodiments, the labor functionalization system 140 may facilitate assigning workers 164 to tasks 156 based on knowledge or qualifications of each of the workers. FIG. 9 illustrates an exemplary embodiment of a knowledge base 344 whereby various workers 164 within the labor pool 144 may be assigned to portions of a project on the basis of their knowledge, qualifications, skills, and the like. The knowledge base 344 may be comprised of one or more business units 348. Each business unit 348 may be comprised of all that certain work that is directed to meet the needs, or requirements, of an individual business customer, or client. In the exemplary embodiment of FIG. 9, an executive 352 may be selected to oversee the knowledge base 344, and a manager 356 may be assigned to each business unit 348 within the knowledge base. It will be recognized that the knowledge base 344 is hierarchical, and thus the illustrated embodiment of the knowledge base indicates that the managers 356 report to, and receive direction from, the executive 352. Furthermore, the business unit 348 is comprised of all the workflows 184, workitems 172, and tasks 156 that are to be performed to meet the needs of the business customer.

In some embodiments, the knowledge base 344 may serve as a record of all those certain workers 164, 352, 356 that are assigned to perform currently pending work. As shown in FIG. 9, the knowledge base 344 contains all the tasks 156 that are scheduled to be performed, as well as an individual work queue 360 for each of the workers 164 assigned to work on the tasks 156 within each business unit 348. As will be appreciated, the individual work queue 360 may be comprised of all those certain tasks 156 that are assigned to a particular worker 164. It is envisioned that the knowledge base 344, as well as the assignments therein, may be stored on the database server system 110 and accessible to the labor functionalization system 140 by way of the interface 112. It is further envisioned that the knowledge base 344 may be configured to facilitate making any necessary changes to any portion or aspect of the one or more business units 348 contained therein.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. A workflow labor optimization system configured to enable a multiplicity of end-users to assign groups of specialized workers to perform diverse tasks that meet the needs of one or more business clients, the system comprising:
a work partitioning system configured to enable the multiplicity of end-users to at least organize new work into logical groups of tasks, arrange complimentary tasks into workitem sequences that are tailored to address the needs of the one or more business clients, and organize the workitem sequences into workflows;
a dependencies system configured to enable the multiplicity of end-users to at least initiate work by establishing a schedule whereby workitems may be completed;
an interval system configured to enable the multiplicity of end-users to control the progression of workitems by establishing at least due dates and due date rules between tasks comprising the workitems;
a labor functionalization system configured to enable the multiplicity of end-users to at least select workers from specialized labor pools and pair the workers with appropriate tasks;
a host site configured to be accessible to the multiplicity of end-users by way of a communications network; and
a database server system comprising a non-transient machine-readable medium for storing information needed during the operation of the workflow labor optimization system.

2. The system of claim 1, wherein the host site is configured to provide the multiplicity of end-users with access to the workflow labor optimization system by way of an interface.

3. The system of claim 2, wherein the work partitioning system comprises a component systems package that is configured to be stored on a memory of an application server system, and wherein the interface is configured as a software application comprising a portion of the workflow labor optimization system and providing access thereto.

4. The system of claim 2, wherein the work partitioning system comprises a component systems package that is configured to be stored on a memory of the database server system, and wherein the interface is configured to provide communication between an application server system and the component systems package.

5. The system of claim 1, wherein the dependencies system is configured to enable the multiplicity of end-users to assign predecessors to tasks comprising one or more workitems so as to control the progression of the one or more workitems.

6. The system of claim 1, wherein the dependencies system is configured to enable the multiplicity of end-users to control the progression of a workflow by establishing links between tasks comprising different workitems within the workflow, the links being comprised of wires placed between the tasks.

7. The system of claim 1, wherein the interval system is configured to enable the multiplicity of end-users to set Time Units and Due Date Rules for one or more tasks comprising a workitem so as to control when the one or more tasks are to be performed in relation to a Project Received Date and relative to one another of the one or more tasks.

8. The system of claim 1, wherein the labor functionalization system is configured to enable the workers to be paired with the appropriate tasks based on factors that affect performing the tasks, including at least the types of inbound tasks, employee qualifications, an allotted time to complete each of the tasks, employee work capacity, current workload, forecasted employee work capacity.

9. The system of claim 8, wherein a portion of the labor functionalization system comprises a constraints solver that is configured to assign inbound tasks to the most suitable workers based on criteria specified by the multiplicity of end-users.

10. The system of claim 9, wherein the labor functionalization system is configured to return an assignment result once all of the inbound tasks are paired with suitable workers.

11. The system of claim 1, wherein the labor functionalization system comprises a knowledge base configured to serve as a record of all those certain workers that are assigned to perform currently pending tasks.

12. The system of claim 11, wherein the knowledge base contains all the tasks that are scheduled to be performed, as well as an individual work queue for each of the workers assigned to work on the tasks pertaining to the one or more business clients.

13. The system of claim 12, wherein the knowledge base is configured to facilitate making any necessary changes to any portion or aspect of tasks pertaining to the one or more business clients.

14. A method for a workflow labor optimization system to enable a multiplicity of end-users to assign groups of workers to perform tasks that meet the needs of one or more business clients, the system comprising:
enabling new work to be partitioned into logical groups of tasks and arranged into workitems;
allowing a schedule to be established whereby the workitems may be completed;
allowing at least due dates and due date rules to be associated with the tasks to control the progression of the workitems;
enabling workers to be paired with appropriate tasks comprising the workitems;
providing a host site whereby the multiplicity of end-users may access the workflow labor optimization system; and
storing information needed during operation of the workflow labor optimization system on a non-transient machine-readable medium of a database server system.

15. The method of claim 14, wherein providing the host site comprises making the host site accessible to the multiplicity of end-users by way of a communications network.

16. The method of claim 14, wherein allowing the schedule to be established further comprises providing a dependencies system whereby the multiplicity of end-users may assign predecessors to tasks comprising one or more workitems so as to control the progression of the one or more workitems.

17. The method of claim 16, wherein providing the dependencies system further comprises enabling the multiplicity of end-users to control the progression of the workitems by establishing links between tasks within the one or more workitems.

18. The method of claim 14, wherein allowing at least due dates and due date rules further comprises configuring an interval system to enable the multiplicity of end-users to control the progression of workitems by associating the at least due dates and the due date rules with the tasks comprising the workitems.

19. The method of claim 14, wherein enabling workers to be paired further comprises providing a labor functionalization system whereby the multiplicity of end-users may select the workers from specialized labor pools and assign the workers to perform the most appropriate of the tasks.

20. The method of claim 14, wherein enabling new work to be partitioned further comprises providing a work partitioning system whereby the multiplicity of end-users may arrange complimentary tasks into workitem sequences and organize the workitem sequences into workflows that are tailored to address the needs of the one or more business clients.
